(19) United States
(12) Patent Application Publication
(10) Pub. No.: US 2015/0245348 A1
(43) Pub. Date: Aug. 27, 2015

(54) APPARATUS AND METHOD FOR HANDLING A MAC ENTITY RESET AND UPLINK MODULATION SCHEME OPERATION

(71) Applicant: QUALCOMM Incorporated, San Diego, CA (US)

(72) Inventors: Yongsheng Shi, San Diego, CA (US); Sitaramanjaneyulu Kanamarlapudi, San Diego, CA (US)

(21) Appl. No.: 14/449,653

(22) Filed: Aug. 1, 2014

Related U.S. Application Data
(60) Provisional application No. 61/942,832, filed on Feb. 21, 2014.

(51) Int. Cl. H04W 72/04; H04L 1/00

(52) U.S. Cl. CPC H04W 72/0413; H04L 1/0014

(57) ABSTRACT

The disclosure provides a method, apparatus, and computer program product directed towards performing a medium access control (MAC) entity reset in a user equipment (UE). A condition associated with a commencement or stoppage of an uplink quadrature amplitude modulation (QAM) scheme is detected within a UE. Here, the condition is a network communication lacking either a modulation scheme configuration information element or a MAC reset indicator. A MAC entity on the UE is then reset in response to a detection of the condition.

### CROSS-REFERENCE TO RELATED APPLICATIONS

This application claims priority to and the benefit of provisional patent application No. 61/942,832, filed in the United States Patent and Trademark Office on Feb. 21, 2014, the entire content of which is incorporated herein by reference.

### TECHNICAL FIELD

Aspects of the present disclosure relate generally to wireless communication systems, and more particularly, to performing a medium access control (MAC) entity reset during uplink 16QAM or 64QAM operation.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

Generally, wireless mobile equipment (called a mobile station (MS), user equipment (UE), access terminal (AT), etc. in various literature) configured for UMTS can now utilize any of various modulation schemes for uplink transmissions. For instance, the 16QAM modulation scheme was introduced in Release 7 of the 3GPP standards, which can increase the UE uplink data rate up to 11 Mbps. Similarly, the 64QAM modulation scheme was introduced in Release 11 of the 3GPP standards, which can increase UE uplink data rate up to 23 Mbps. The introduction of these modulation schemes, however, has also introduced more potential scenarios for the UE to manage. If handled improperly, some of these scenarios may cause the UE to exhibit unspecified behavior. Accordingly, a more robust handling protocol for such scenarios is desired.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods, apparatuses, computer program products, and processing systems directed towards performing a medium access control (MAC) entity reset in a user equipment (UE). In one aspect, the disclosure provides a method operable on a UE, which includes ascertaining whether the UE has begun or stopped operating in an uplink quadrature amplitude modulation (QAM) scheme. The method further includes detecting a condition in which a network communication lacks either a modulation scheme configuration information element or a MAC reset indicator. In this particular implementation, the condition is also associated with a commencement or stoppage of the uplink QAM scheme. A MAC entity on the UE is then reset in response to a detection of the condition.

In another aspect, a UE comprising a detection circuit and a reset circuit is disclosed. Here, the detection circuit is configured to detect a condition in which a network communication lacks either a modulation scheme configuration information element or a MAC reset indicator, whereas the reset circuit is configured to reset a MAC entity on the UE in response to a detection of the condition. In an aspect of the disclosure, this condition is associated with a commencement or stoppage of an uplink QAM scheme.

In a further aspect, another UE is disclosed. Here, the UE comprises means for ascertaining whether the UE has begun or stopped operating in an uplink QAM scheme, and means for detecting a condition in which a network communication lacks either a modulation scheme configuration information element or a MAC reset indicator. In this implementation, the condition is also associated with a commencement or stoppage of the uplink QAM scheme. The UE then further includes means for resetting a MAC entity on the UE in response to a detection of the condition.

In yet another aspect, a non-transitory machine-readable storage medium having one or more instructions stored thereon is disclosed. When executed by at least one processor, the one or more instructions cause the at least one processor to detect a condition in which a network communication lacks either a modulation scheme configuration information element or a MAC reset indicator. Here, the condition is associated with a commencement or stoppage of an uplink QAM scheme. The instructions then further include instructions to reset a MAC entity on the UE in response to a detection of the condition.

These and other disclosed aspects will become more fully understood upon a review of the detailed description, which follows. Other aspects, features, and aspects of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates an exemplary UE operation at various instances of time according to some aspects of the disclosure.

FIG. 2 illustrates a first exemplary implementation of a MAC reset protocol according to some aspects of the disclosure.

FIG. 3 is a flow chart illustrating an exemplary MAC reset procedure according to the MAC reset protocol illustrated in FIG. 2.

FIG. 4 illustrates a second exemplary implementation of a MAC reset protocol according to some aspects of the disclosure.

FIG. 5 is a flow chart illustrating an exemplary MAC reset procedure according to the MAC reset protocol illustrated in FIG. 4.

FIG. 6 is a block diagram illustrating an example of a hardware implementation for a user equipment employing a processing system according to some aspects of the disclosure.

FIG. 7 is a block diagram illustrating exemplary MAC reset protocol components according to an aspect of the disclosure.

FIG. 8 is a block diagram conceptually illustrating an example of a telecommunications system.

FIG. 9 is a conceptual diagram illustrating an example of an access network.

FIG. 10 is a conceptual diagram illustrating an example of a radio protocol architecture for the user and control plane.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

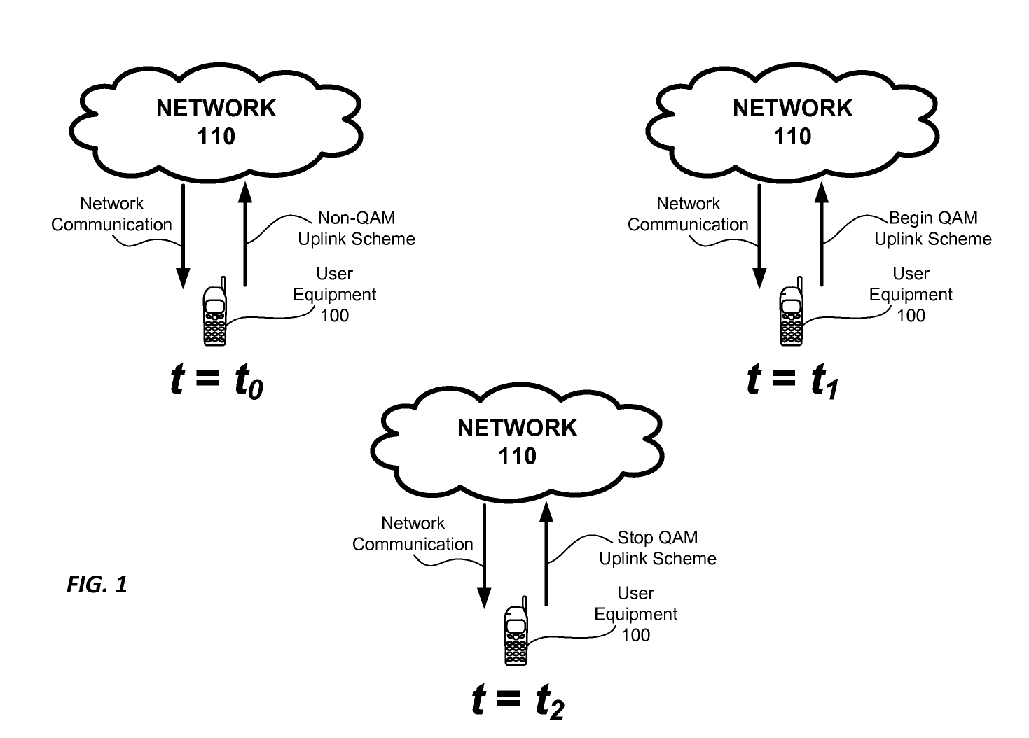

In an aspect of the disclosure, a MAC reset protocol is contemplated and directed towards an improved handling of uplink modulation scheme scenarios that may cause a UE to exhibit unspecified behavior. The contemplated MAC reset protocol is particularly directed towards specifying UE behavior in various scenarios associated with operating the UE according to an uplink QAM scheme. As illustrated in FIG. 1, for example, it should be appreciated that various scenarios exist in which a UE 100 receives communications from a network 110 to facilitate operating the UE according to either a QAM scheme or a non-QAM scheme. It should be further appreciated that some of these network communications are active set update (ASU) messages, wherein processing such messages may include parsing the message for particular information elements. For instance, as specified in Release 7 and later versions of the 3GPP standards, the ASU message may include an “UL 16 QAM configuration” information element or an “UL 64 QAM configuration” information element. For example, the UL 16 QAM configuration IE may appear as follows:

TABLE 1
UL 16QAM Configuration

| Information | | |
|---|---|---|
| Element/Group name | Semantics description | Version |
| UL 16QAM settings | Presence of this IE indicates that | REL-7 |
| | the UE should operate in 16QAM | |
| | mode; absence indicates that the | |
| | UE is not to operate in 16QAM | |
| | mode. | |
| MAC-es/e reset indicator | TRUE Indicates the MAC-es/e or | REL-7 |
| | MAC-i/is entity needs to be reset. | |
| E-TFCI table index | Indicates which standardised E- | REL-7 |
| | TFCI TB size table shall be used. | |

Similarly, the UL 64 QAM configuration IE may appear as follows:

TABLE 2
UL 64QAM Configuration

| Information | | |
|---|---|---|
| Element/Group name | Semantics description | Version |
| UL 64QAM settings | Presence of this IE indicates that | REL-11 |
| | the UE should operate in 64QAM | |
| | mode; absence indicates that the | |
| | UE is not to operate in 64QAM | |
| | mode. | |
| MAC-is/i reset indicator | TRUE Indicates that MAC-i/is | REL-11 |
| | entity needs to be reset. | |

Within the UL 16 QAM IE, the presence of a “UL 16QAM settings” IE would indicate that UE 100 should operate in 16QAM mode, whereas the absence of this information element would indicate that UE 100 is not to operate in 16QAM mode. Furthermore, within the UL 16QAM settings IE, the network can provide to the UE 100 information relating to the particular configuration settings of the 16 QAM uplink transmission. Similarly, the presence of a “UL 64 QAM settings” IE would indicate that the UE 100 should operate in 64QAM mode, whereas the absence of this IE would indicate that the UE 100 is not to operate in 64QAM mode. Furthermore, within the UL 64QAM settings IE, the network can provide to the UE 100 information relating to the particular configuration settings of the 64 QAM uplink transmission.

With respect to the “MAC-es/e reset indicator” IE within a UL 16QAM configuration IE, or the “MAC-is/i reset indicator” IE within a UL 64QAM configuration IE, Release 7 and later versions of the 3GPP standards specify that the MAC-es/e or MAC-i/is entity of UE 100 needs to be reset if this information element is TRUE. Various scenarios in which ASU messages are parsed for these particular information elements, in accordance with aspects of the disclosure, are contemplated.

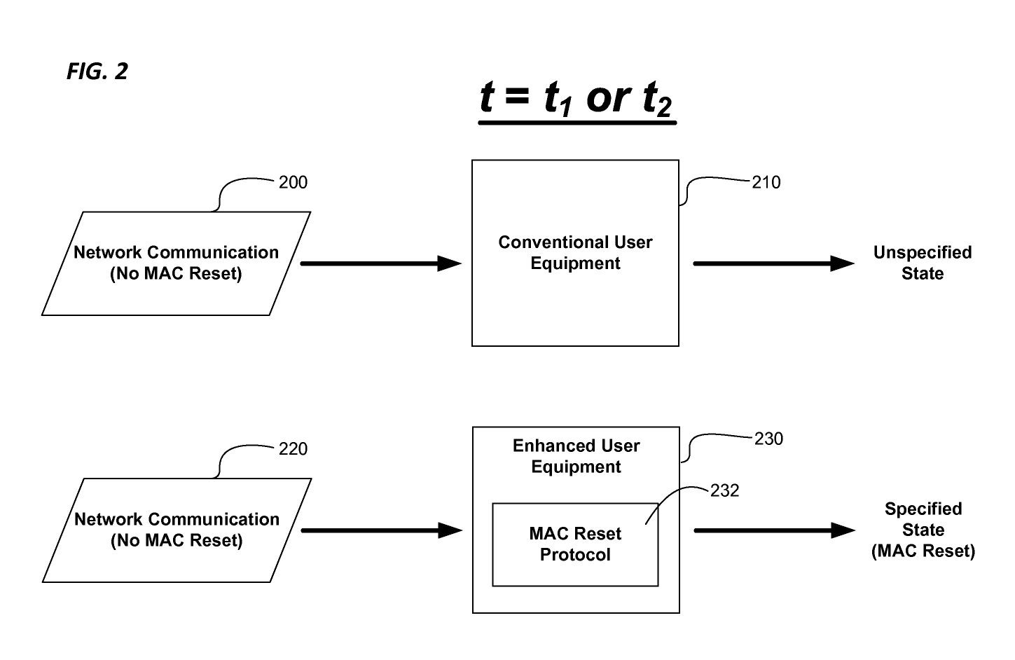

For instance, as illustrated in FIG. 2, a first scenario is contemplated in which a UE either begins or stops an uplink QAM scheme (i.e., in reference to FIG. 1, where t=t₁ or t₂). As illustrated, if a conventional UE 210 receives a network communication 200 (e.g., an ASU message) that lacks a MAC reset while conventional UE 210 either begins or stops an uplink QAM scheme, conventional UE 210 would enter an unspecified state. Indeed, as agreed by in the 3GPP specification (See section 8.3.4.3 in 25.331, which is incorporated herein by reference in its entirety), the behavior of conventional UE 210 in such scenario would be unspecified. In an aspect of the disclosure, however, an enhanced UE 230 includes a MAC reset protocol 232, wherein MAC reset protocol 232 is configured to specify a particular state for enhanced UE 230. Namely, if enhanced UE 230 receives a network communication 220 (e.g., an ASU message) that lacks a MAC reset while enhanced UE 230 either begins or stops an uplink QAM scheme, MAC reset protocol 232 would facilitate having enhanced UE 230 enter a specified state in which enhanced UE 230 automatically resets its MAC entity.

A particular example of the aforementioned scenario is now provided. For this example, the UE operates in either UL 16QAM or 64QAM, which means that all cells in the active set of the UE support UL 16QAM or 64QAM. The network then sends the UE an active set update message in which a legacy cell is added to the active set (i.e., a cell that does not support UL 16QAM or 64QAM). Here, since the newly added legacy cell does not support UL 16QAM or 64QAM, the UE must stop operating in its current modulation scheme (i.e., UL 16QAM or 64QAM). In this scenario, however, it is further assumed that a MAC reset indicator is not included in the active set update message, which may be problematic for the UE. Namely, as previously mentioned, UE behavior in such a scenario is unspecified. The UE could thus unpredictably exhibit any of various behaviors, including: a) reject the active set update message; b) accept the active set update message, and NOT perform a MAC reset; or c) accept the active set update message, and perform a MAC reset. With the MAC reset protocol disclosed herein, however, a specific handling of such scenario is automatically triggered in which the UE accepts the active set update message and resets its MAC entity. To this end, it should be appreciated that when UL 16QAM or UL 64QAM starts or stops, if the UE does not perform a MAC entity reset, data loss or even a call drop may result because of the modulation change. Furthermore, if the UE rejects the active set update message in this scenario, rejecting the message may cause a call drop as well. Accordingly, of the three aforementioned UE behaviors, configuring the UE to include a MAC reset protocol that automatically accepts the active set update message and resets the MAC entity, whenever the active set update message results in either UL 16QAM or 64QAM starting or stopping appears to be most desirable.

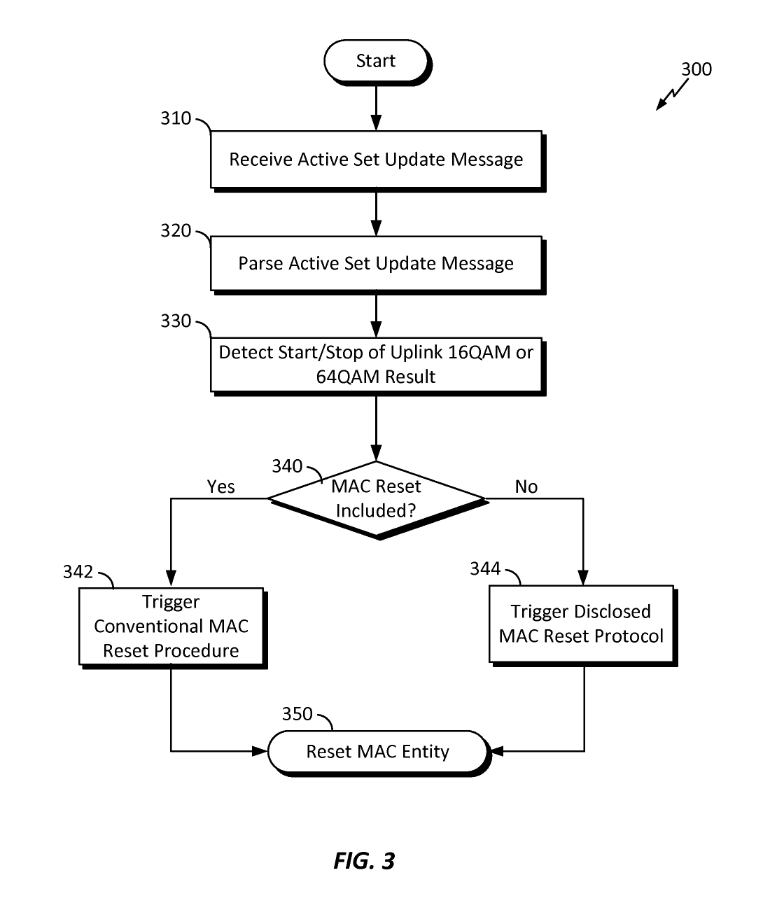

Referring next to FIG. 3, a flowchart illustrating a procedure 300 that implements MAC reset protocol 232 in accordance with an aspect of the present disclosure is provided. In an aspect of the disclosure, procedure 300 is performed at a UE such as enhanced UE 230 of FIG. 2. As illustrated, procedure 300 begins at block 310 where the UE receives an active set update message from the network, and subsequently parses the message at block 320. At block 330, the UE then detects that the active set update message will result in either a commencement or stoppage of an uplink 16QAM or 64QAM. For instance, as previously stated, a resulting stoppage may be detected if the message indicates the addition of a legacy cell to the UE's active set.

Upon detecting either a commencement or stoppage of an uplink 16QAM or 64QAM at block 330, procedure 300 then proceeds to block 340 where the UE determines whether a MAC reset was included in the active set update message. If a MAC reset was indeed included, a conventional MAC reset procedure is triggered at block 342, and procedure 300 then concludes with the UE performing a MAC entity reset at block 350 according to the conventional procedure. Otherwise, if a MAC reset was not included, the internal MAC reset protocol disclosed herein is triggered at block 344, and procedure 300 then concludes with the UE performing a MAC entity reset at block 350 according to the disclosed protocol.

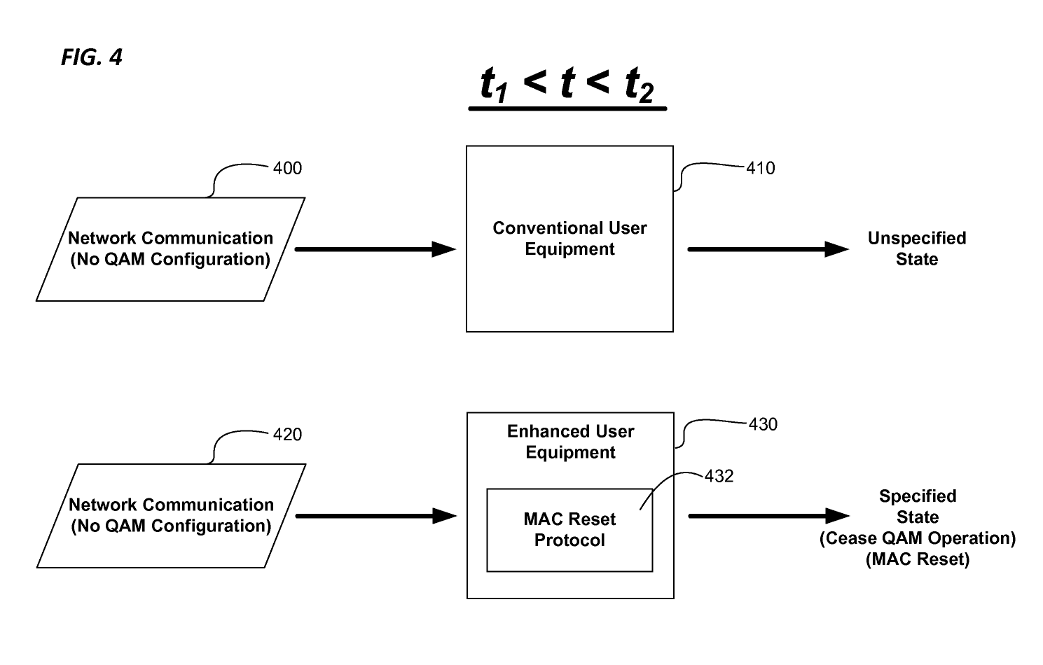

As illustrated in FIG. 4, a second scenario is also contemplated in which a UE currently operates in an uplink QAM scheme (i.e., where t₁<t<t₂, with reference to FIG. 1). As illustrated, if a conventional UE 410 receives a network communication 400 (e.g., an ASU message) that lacks a QAM configuration information element while conventional UE 410 operates according to an uplink QAM scheme, conventional UE 410 would enter an unspecified state, as agreed by in the 3GPP specification (See section 8.3.4.3 in 25.331). In an aspect of the disclosure, however, an enhanced UE 430 includes a MAC reset protocol 432, wherein MAC reset protocol 432 is configured to specify a particular state for enhanced UE 430. Namely, if enhanced UE 430 receives a network communication 420 (e.g., an ASU message) that lacks a QAM configuration information element while enhanced UE 430 operates according to an uplink QAM scheme, MAC reset protocol 432 would facilitate having enhanced UE 430 enter a specified state in which enhanced UE 430 automatically ceases QAM operation and resets its MAC entity.

A particular example of this second scenario is now provided. For this example, the network sends a UE an active set update message while the UE operates in either UL 16QAM or 64QAM. In this scenario, however, the active set update message is sent without including the information element “UL 16QAM configuration” or “UL 64QAM configuration”. Here, as agreed by in the 3GPP specification (See section 8.3.4.3 in 25.331), UE behavior would again be unspecified. The UE could thus unpredictably exhibit any of various behaviors, including: a) reject the active set update message; b) accept the active set update message, and continue operating in UL 16QAM or 64QAM; or c) accept the active set update message, and cease operating in UL 16QAM or 64QAM. With the MAC reset protocol disclosed herein, however, a specific handling of such scenario is automatically triggered in which the UE accepts the active set update message, ceases operating in its current uplink modulation scheme (i.e., UL 16QAM or 64QAM), and reset its MAC entity if the active set update message does not include a “UL 16QAM configuration” or “UL 64QAM configuration” information element. To this end, it should again be appreciated that a call may be dropped in such scenario if the UE rejects the active set update message. If the UE accepts the active set update message and continues with UL 16QAM or UL 64QAM mode operation, however, such behavior may not be the network intention. Indeed, as specified in 25.331 of the 3GPP specification, the presence of information element “UL 16QAM settings” or “UL 64QAM settings”, which are respectively child information elements of “UL 16QAM configuration” and “UL 64QAM configuration”, determines if UL 16QAM or UL 64QAM starts or stops. Thus, the absence of “UL 16QAM configuration” or “UL 64 QAM configuration” would indicate an intent to stop the corresponding mode of operation. Accordingly, of the three aforementioned UE behaviors for this particular scenario, configuring the UE to include a MAC reset protocol that automatically accepts the active set update message, causes the UE to stop operating in in its current uplink modulation scheme (i.e., UL 16QAM or 64QAM), and resets the MAC entity, whenever an active set update message does not include a “UL 16QAM configuration” or “UL 64QAM configuration” information element appears to be most desirable.

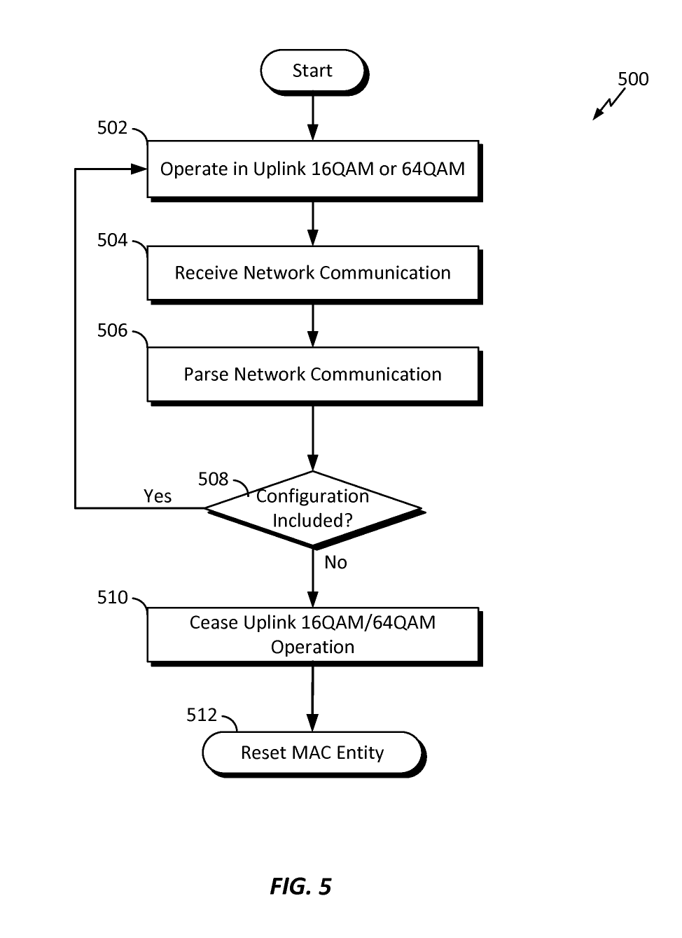

Referring next to FIG. 5, a flowchart illustrating a procedure 500 that implements MAC reset protocol 432 in accordance with an aspect of the present disclosure is provided. In an aspect of the disclosure, the procedure 500 may be performed at a UE such as enhanced UE 430 of FIG. 4. Procedure 500 begins at block 502 where the UE operates in either UL 16QAM or 64QAM. Procedure 500 then proceeds with the UE receiving a network communication (e.g., an active set update message) at block 504. Here, as stated previously, it may be desirable to have the UE reset its MAC entity based on the contents of the communication received from the network. Accordingly, at block 506, the UE parses the network communication to determine at block 508 whether a “16QAM configuration” or “64QAM configuration” information element was included. If either a “16QAM configuration” or “64QAM configuration” information element was indeed included in the network communication, procedure 500 loops back to block 502 where the UE continues to operate in its current modulation scheme (i.e., UL 16QAM or 64QAM). Otherwise, if neither of a “16QAM configuration” or “64QAM configuration” information element was included in the network communication, procedure 500 proceeds to block 510. At block 510, the UE ceases to operate in its current modulation scheme (i.e., UL 16QAM or 64QAM), and procedure 500 then concludes with the UE performing a MAC entity reset in block 512.

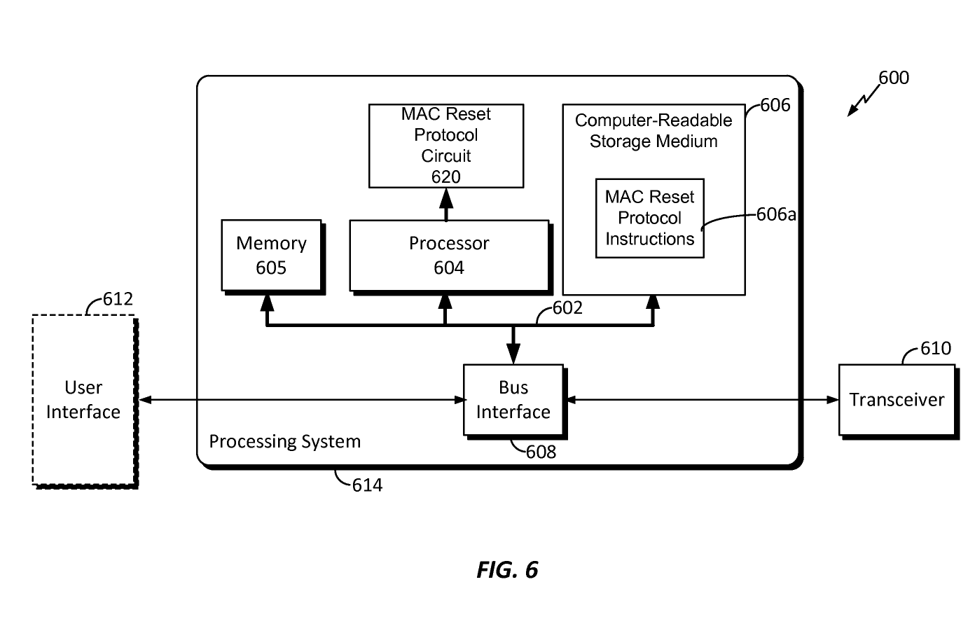

Referring next to FIG. 6 is a conceptual diagram illustrating an example of a hardware implementation for a user equipment (UE) 600 employing a processing system 614, wherein UE 600 may be a UE such as enhanced UE 230 and/or enhanced UE 430 as illustrated FIGS. 2 and 4, respectively. In accordance with various aspects of the disclosure, an element, or any portion of an element, or any combination of elements may be implemented with a processing system 614 that includes one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 604, as utilized in UE 600, may be used to implement any one or more of the processes described herein and illustrated in FIGS. 3 and 5.

In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

In an aspect of the disclosure, computer-readable medium 606 is configured to include MAC reset protocol instructions 606a to facilitate implementing a MAC reset protocol, as shown. In a similar aspect, such protocol can instead be implemented via hardware by coupling processor 604 to MAC reset protocol circuit 620, as shown. Moreover, it is contemplated that the MAC reset protocol may be implemented via any combination of MAC reset protocol instructions 606a and/or MAC reset protocol circuit 620.

Referring back to the remaining elements of FIG. 6, it should be appreciated that processor 604 is responsible for managing the bus 602 and general processing, including the execution of software stored on the computer-readable medium 606. The software, when executed by the processor 604, causes the processing system 614 to perform the various functions described below for any particular apparatus. The computer-readable medium 606 may also be used for storing data that is manipulated by the processor 604 when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

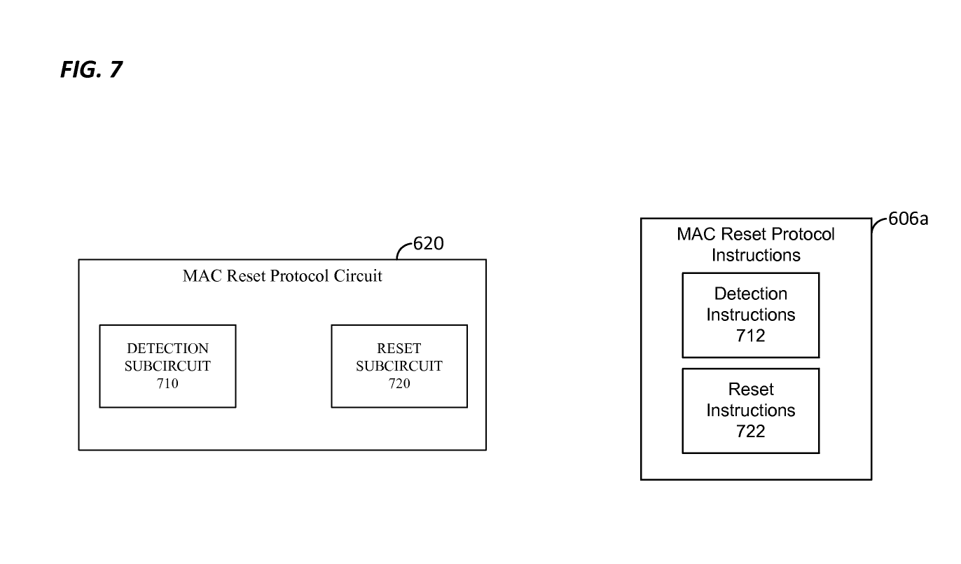

Furthermore, as illustrated in FIG. 7, each of MAC reset protocol circuit 620 and MAC reset protocol instructions 606a may facilitate implementing the disclosed MAC reset protocol via any of a plurality of subcomponents. For instance, MAC reset protocol circuit 620 may comprise detection sub-circuit 710 and reset sub-circuit 720, whereas MAC reset protocol instructions 606a may comprise detection instructions 712 and reset instructions 722. Here, either of detection sub-circuit 710 and/or detection instructions 712 may be directed towards detecting a condition associated with a commencement, stoppage, or operation of an uplink QAM scheme, whereas either of reset sub-circuit 720 and/or reset instructions 722 may be directed towards resetting a MAC entity on the UE in response to a detection of the condition. In an aspect of the disclosure, this condition may include receiving a network communication that lacks either a modulation scheme configuration information element or a MAC reset indicator.

As previously stated, the disclosed MAC reset protocol is at least directed towards two particular scenarios. To facilitate implementing the MAC reset protocol within the context of either scenario, it is contemplated that either of detection sub-circuit 710 and/or detection instructions 712 may be configured to address one or both scenarios. For instance, with respect to the first scenario where UE 600 receives a network communication (e.g., an ASU message) that lacks a MAC reset while UE 600 either begins or stops an uplink QAM scheme, it is contemplated that either of detection sub-circuit 710 and/or detection instructions 712 may be configured to analyze a content of an active set update message. To this end, either of detection sub-circuit 710 and/or detection instructions 712 may be further configured to ascertain whether the active set update message results in the commencement or stoppage of an uplink QAM scheme. For instance, detection sub-circuit 710 and/or detection instructions 712 may be configured to cease operation in the uplink QAM scheme upon detecting a notification in the active set update message to add a cell unable to support the uplink QAM scheme to an active set of the UE.

With respect to the second scenario where UE 600 receives a network communication (e.g., an ASU message) that lacks a QAM configuration information element while UE 600 operates according to an uplink QAM scheme, it is contemplated that either of detection sub-circuit 710 and/or detection instructions 712 may also be configured to analyze a content of an active set update message. To this end, either of detection sub-circuit 710 and/or detection instructions 712 may be further configured to cease operation in the uplink QAM scheme upon detecting an omission of a modulation scheme configuration information element in the active set update message.

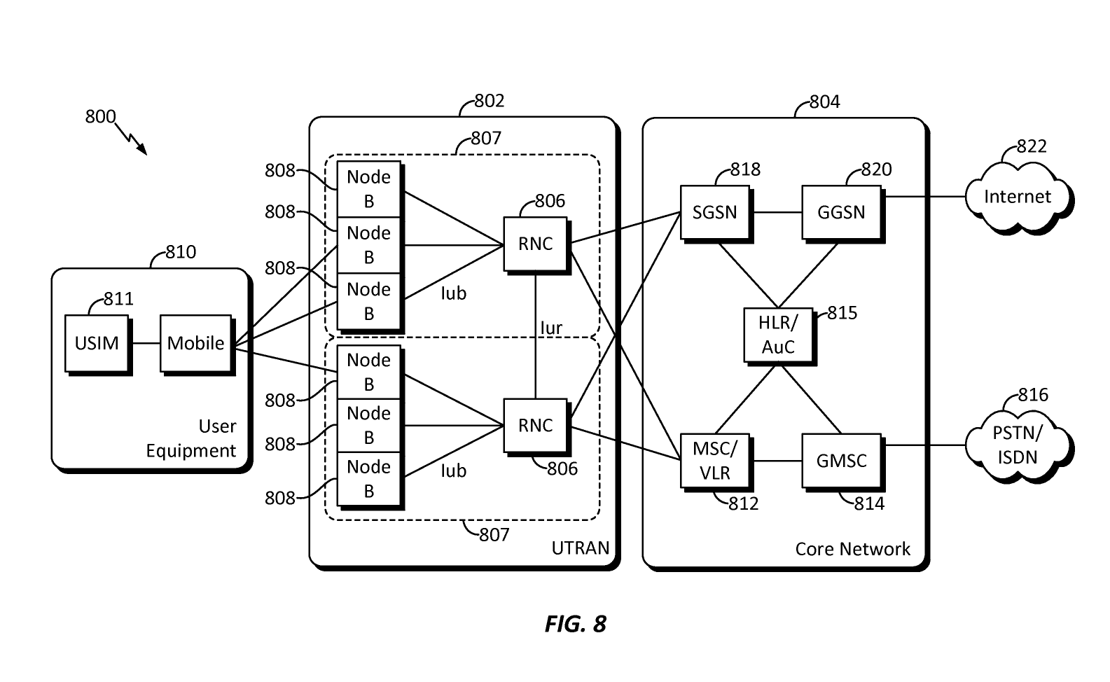

The various concepts presented throughout this disclosure may be implemented across a broad variety of telecommunication systems, network architectures, and communication standards. Referring now to FIG. 8, as an illustrative example without limitation, various aspects of the present disclosure are illustrated with reference to a Universal Mobile Telecommunications System (UMTS) system 800. A UMTS network includes three interacting domains: a core network 804, a radio access network (RAN) (e.g., the UMTS Terrestrial Radio Access Network (UTRAN) 802), and a user equipment (UE) 810. Among several options available for a UTRAN 802, in this example, the illustrated UTRAN 802 may employ a W-CDMA air interface for enabling various wireless services including telephony, video, data, messaging, broadcasts, and/or other services. The UTRAN 802 may include a plurality of Radio Network Subsystems (RNSs) such as an RNS 807, each controlled by a respective Radio Network Controller (RNC) such as an RNC 806. Here, the UTRAN 802 may include any number of RNCs 806 and RNSs 807 in addition to the illustrated RNCs 806 and RNSs 807. The RNC 806 is an apparatus responsible for, among other things, assigning, reconfiguring, and releasing radio resources within the RNS 807. The RNC 806 may be interconnected to other RNCs (not shown) in the UTRAN 802 through various types of interfaces such as a direct physical connection, a virtual network, or the like using any suitable transport network.

The geographic region covered by the RNS 807 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 808 are shown in each RNS 807; however, the RNSs 807 may include any number of wireless Node Bs. The Node Bs 808 provide wireless access points to a core network 804 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 810 may further include a universal subscriber identity module (USIM) 811, which contains a user's subscription information to a network. For illustrative purposes, one UE 810 is shown in communication with a number of the Node Bs 808. The downlink (DL), also called the forward link, refers to the communication link from a Node B 808 to a UE 810 and the uplink (UL), also called the reverse link, refers to the communication link from a UE 810 to a Node B 808.

The core network 804 can interface with one or more access networks, such as the UTRAN 802. As shown, the core network 804 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 804 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 804 supports circuit-switched services with a MSC 812 and a GMSC 814. In some applications, the GMSC 814 may be referred to as a media gateway (MGW). One or more RNCs, such as the RNC 806, may be connected to the MSC 812. The MSC 812 is an apparatus that controls call setup, call routing, and UE mobility functions. The MSC 812 also includes a visitor location register (VLR) that contains subscriber-related information for the duration that a UE is in the coverage area of the MSC 812. The GMSC 814 provides a gateway through the MSC 812 for the UE to access a circuit-switched network 816. The GMSC 814 includes a home location register (HLR) 815 containing subscriber data, such as the data reflecting the details of the services to which a particular user has subscribed. The HLR is also associated with an authentication center (AuC) that contains subscriber-specific authentication data. When a call is received for a particular UE, the GMSC 814 queries the HLR 815 to determine the UE's location and forwards the call to the particular MSC serving that location.

The illustrated core network 804 also supports packet-switched data services with a serving GPRS support node (SGSN) 818 and a gateway GPRS support node (GGSN) 820. General Packet Radio Service (GPRS) is designed to provide packet-data services at speeds higher than those available with standard circuit-switched data services. The GGSN 820 provides a connection for the UTRAN 802 to a packet-based network 822. The packet-based network 822 may be the Internet, a private data network, or some other suitable packet-based network. The primary function of the GGSN 820 is to provide the UEs 810 with packet-based network connectivity. Data packets may be transferred between the GGSN 820 and the UEs 810 through the SGSN 818, which performs primarily the same functions in the packet-based domain as the MSC 812 performs in the circuit-switched domain.

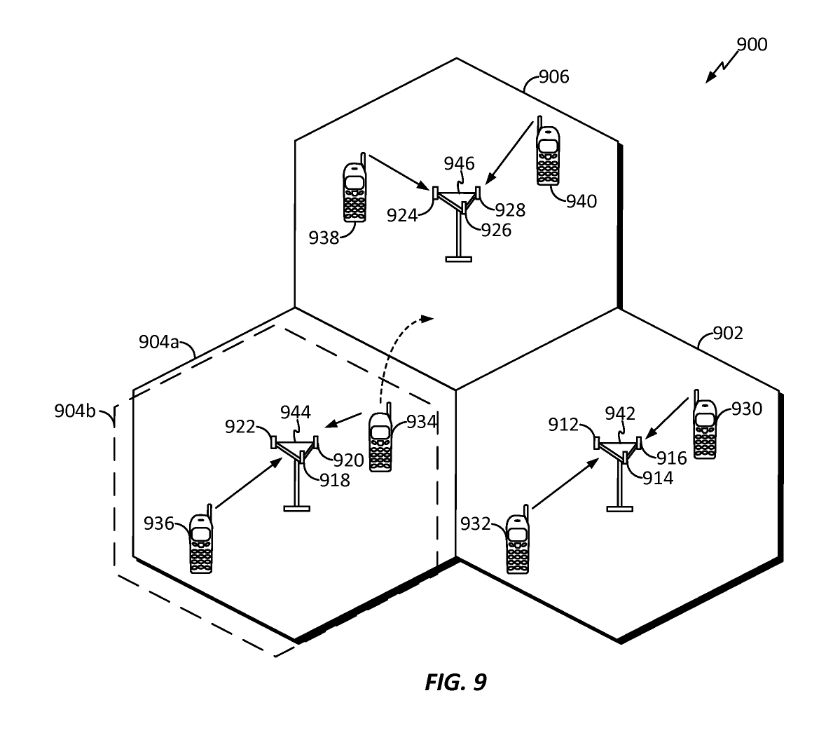

The UTRAN 802 is one example of a RAN that may be utilized in accordance with the present disclosure. Referring to FIG. 9, by way of example and without limitation, a simplified schematic illustration of a RAN 900 in a UTRAN architecture is illustrated. The system includes multiple cellular regions (cells), including cells 902, 904, and 906, each of which may include one or more sectors. Cells may be defined geographically (e.g., by coverage area) and/or may be defined in accordance with a frequency, scrambling code, etc. That is, the illustrated geographically-defined cells 902, 904, and 906 may each be further divided into a plurality of cells, e.g., by utilizing different scrambling codes. For example, cell 904a may utilize a first scrambling code, and cell 904b, while in the same geographic region and served by the same Node B 944, may be distinguished by utilizing a second scrambling code.

In a cell that is divided into sectors, the multiple sectors within a cell can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 may each correspond to a different sector. In cell 906, antenna groups 924, 926, and 928 may each correspond to a different sector.

The cells 902, 904, and 906 may include several UEs that may be in communication with one or more sectors of each cell 902, 904, or 906. For example, UEs 930 and 932 may be in communication with Node B 942, UEs 934 and 936 may be in communication with Node B 944, and UEs 938 and 940 may be in communication with Node B 946. Here, each Node B 942, 944, and 946 may be configured to provide an access point to a core network 804 (see FIG. 8) for all the UEs 930, 932, 934, 936, 938, and 940 in the respective cells 902, 904, and 906.

During a call with a source cell, or at any other time, the UE 936 may monitor various parameters of the source cell as well as various parameters of neighboring cells. Further, depending on the quality of these parameters, the UE 936 may maintain communication with one or more of the neighboring cells. During this time, the UE 936 may maintain an Active Set, that is, a list of cells to which the UE 936 is simultaneously connected (i.e., the UTRAN cells that are currently assigning a downlink dedicated physical channel DPCH or fractional downlink dedicated physical channel F-DPCH to the UE 936 may constitute the Active Set).

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. Referring back to FIG. 8, the W-CDMA air interface for UTRAN 802 is based on such DS-CDMA technology and additionally calls for a frequency division duplexing (FDD). FDD uses a different carrier frequency for the uplink (UL) and downlink (DL) between a Node B 808 and a UE 810. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

A high speed packet access (HSPA) air interface includes a series of enhancements to the 3G/W-CDMA air interface between the UE 810 and the UTRAN 802, facilitating greater throughput and reduced latency for users. Among other modifications over prior standards, HSPA utilizes hybrid automatic repeat request (HARQ), shared channel transmission, and adaptive modulation and coding. The standards that define HSPA include HSUPA (high speed uplink packet access, also referred to as enhanced uplink or EUL).

3GPP Release 6 specifications introduced uplink enhancements referred to as Enhanced Uplink (EUL) or High Speed Uplink Packet Access (HSUPA). HSUPA utilizes as its transport channel the EUL Dedicated Channel (E-DCH). The E-DCH is transmitted in the uplink together with the Release 99 DCH. The control portion of the DCH, that is, the DPCCH, carries pilot bits and downlink power control commands on uplink transmissions. In the present disclosure, the DPCCH may be referred to as a control channel (e.g., a primary control channel) or a pilot channel (e.g., a primary pilot channel) in accordance with whether reference is being made to the channel's control aspects or its pilot aspects.

The E-DCH is implemented by physical channels including the E-DCH Dedicated Physical Data Channel (E-DPDCH) and the E-DCH Dedicated Physical Control Channel (E-DPCCH). In addition, HSUPA relies on additional physical channels including the E-DCH HARQ Indicator Channel (E-HICH), the E-DCH Absolute Grant Channel (E-AGCH), and the E-DCH Relative Grant Channel (E-RGCH).

In a wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between the UE 810 and the core network 804, and may include circuit switched and packet switched protocols. The AS provides the lower layers, for signaling between the UTRAN 802 and the UE 810, and may include a user plane and a control plane. Here, the user plane or data plane carries user traffic, while the control plane carries control information (i.e., signaling).

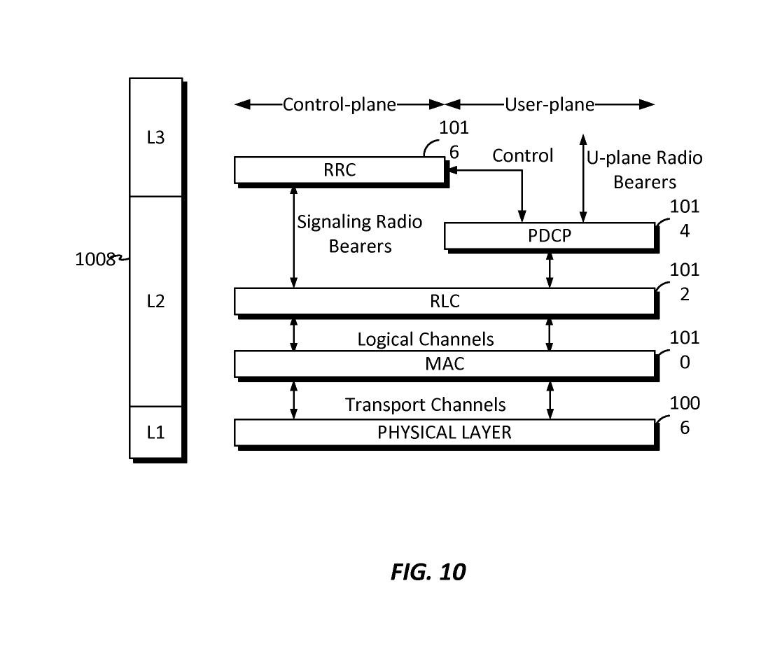

Turning to FIG. 10, the AS is shown with three layers: Layer 1, Layer 2, and Layer 3. Layer 1 is the lowest layer and implements various physical layer signal processing functions. Layer 1 will be referred to herein as the physical layer 1006. The data link layer, called Layer 2 1008, is above the physical layer 1006 and is responsible for the link between the UE 810 and Node B 808 over the physical layer 1006.

At Layer 3, the RRC layer 1016 handles the control plane signaling between the UE 810 and the Node B 808. RRC layer 1016 includes a number of functional entities for routing higher layer messages, handling broadcasting and paging functions, establishing and configuring radio bearers, etc.

In the illustrated air interface, the L2 layer 1008 is split into sublayers. In the control plane, the L2 layer 1008 includes two sublayers: a MAC sublayer 1010 and a radio link control (RLC) sublayer 1012. In the user plane, the L2 layer 1008 additionally includes a packet data convergence protocol (PDCP) sublayer 1014. Although not shown, the UE may have several upper layers above the L2 layer 1008 including a network layer (e.g., IP layer) that is terminated at a PDN gateway on the network side and an application layer that is terminated at the other end of the connection (e.g., far end UE, server, etc.).

The PDCP sublayer 1014 provides multiplexing between different radio bearers and logical channels. The PDCP sublayer 1014 also provides header compression for upper layer data packets to reduce radio transmission overhead, security by ciphering the data packets, and handover support for UEs between Node Bs.

The RLC sublayer 1012 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 1010 provides multiplexing between logical and transport channels. The MAC sublayer 1010 is also responsible for allocating the various radio resources (e.g., resource blocks) in one cell among the UEs. The MAC sublayer 1010 is also responsible for HARQ operations. The MAC sublayer 1010 includes various MAC entities, including but not limited to a MAC-d entity, a MAC-hs/ehs entity, and a MAC-e/es entity.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at a user equipment (UE), comprising:
ascertaining whether the UE has begun or stopped operating in an uplink quadrature amplitude modulation (QAM) scheme;
detecting a condition in which a network communication lacks at least one of a modulation scheme configuration information element or a media access control (MAC) reset indicator, wherein the condition is associated with a commencement or stoppage of the uplink QAM scheme; and
resetting a MAC entity on the UE in response to a detection of the condition.

2. The method of claim 1, further comprising analyzing a content of an active set update message.

3. The method of claim 2, wherein the ascertaining comprises determining whether the active set update message includes a notification to add a legacy cell to an active set of the UE, and wherein the notification triggers a cease of operation in the uplink QAM scheme.

4. The method of claim 2, wherein the detecting comprises detecting an omission of the modulation scheme configuration information element in the active set update message.

5. The method of claim 4, further comprising ceasing an operation in the uplink QAM scheme upon detecting the omission of the modulation scheme configuration information element.

6. The method of claim 2, further comprising accepting the active set update message in response to the detection of the condition.

7. The method of claim 1, wherein the uplink QAM scheme is 16QAM.

8. The method of claim 1, wherein the uplink QAM scheme is 64QAM.

9. A user equipment (UE), comprising:
a detection circuit configured to detect a condition in which a network communication lacks at least one of a modulation scheme configuration information element or a media access control (MAC) reset indicator, wherein the condition is associated with a commencement or stoppage of an uplink quadrature amplitude modulation (QAM) scheme; and
a reset circuit configured to reset a MAC entity on the UE in response to a detection of the condition.

10. The UE of claim 9, wherein the detection circuit is further configured to analyze a content of an active set update message.

11. The UE of claim 10, wherein the detection circuit is configured to cease operation in the uplink QAM scheme upon detecting a notification in the active set update message to add a cell unable to support the uplink QAM scheme to an active set of the UE.

12. The UE of claim 10, wherein the detection circuit is configured to cease operation in the uplink QAM scheme upon detecting an omission of the modulation scheme configuration information element in the active set update message.

13. The UE of claim 10, wherein the detection circuit is configured to ascertain whether the active set update message results in the commencement or stoppage of the uplink QAM scheme.

14. The UE of claim 10, wherein the detection circuit is configured to accept the active set update message in response to the detection of the condition.

15. The UE of claim 9, wherein the uplink QAM scheme is 16QAM.

16. The UE of claim 9, wherein the uplink QAM scheme is 64QAM.

17. A user equipment (UE), comprising:
means for ascertaining whether the UE has begun or stopped operating in an uplink quadrature amplitude modulation (QAM) scheme;
means for detecting a condition in which a network communication lacks at least one of a modulation scheme configuration information element or a media access control (MAC) reset indicator, wherein the condition is associated with a commencement or stoppage of the uplink QAM scheme; and
means for resetting a MAC entity on the UE in response to a detection of the condition.

18. The UE of claim 17, further comprising means for analyzing a content of an active set update message.

19. The UE of claim 18, wherein the means for analyzing comprises means for determining whether the active set update message includes a notification to add a legacy cell to an active set of the UE, and wherein the UE further comprises means for ceasing an operation in the uplink QAM scheme upon detecting the notification.

20. The UE of claim 18, wherein the means for analyzing comprises means for detecting an omission of the modulation scheme configuration information element in the active set update message.

21. The UE of claim 20, further comprising means for ceasing an operation in the uplink QAM scheme upon detecting the omission of the modulation scheme configuration information element.

22. The UE of claim 17, wherein the uplink QAM scheme is 16QAM.

23. The UE of claim 17, wherein the uplink QAM scheme is 64QAM.

24. A non-transitory machine-readable storage medium having one or more instructions stored thereon, which when executed by at least one processor causes the at least one processor to:
detect a condition in which a network communication lacks at least one of a modulation scheme configuration information element or a media access control (MAC) reset indicator, wherein the condition is associated with a commencement or stoppage of an uplink quadrature amplitude modulation (QAM) scheme; and
reset a MAC entity on a user equipment (UE) in response to a detection of the condition.

25. The non-transitory machine-readable storage medium of claim 24, wherein the instructions further comprise instructions to analyze a content of an active set update message.

26. The non-transitory machine-readable storage medium of claim 25, wherein the instructions further comprise instructions to cease operation in the uplink QAM scheme upon detecting a notification in the active set update message to add a cell unable to support the uplink QAM scheme to an active set of the UE.

27. The non-transitory machine-readable storage medium of claim 25, wherein the instructions further comprise instructions to cease operation in the uplink QAM scheme upon detecting an omission of the modulation scheme configuration information element in the active set update message.

28. The non-transitory machine-readable storage medium of claim 25, wherein the instructions further comprise instructions to accept the active set update message in response to the detection of the condition.

29. The non-transitory machine-readable storage medium of claim 24, wherein the uplink QAM scheme is 16QAM.

30. The non-transitory machine-readable storage medium of claim 24, wherein the uplink QAM scheme is 64QAM.
